(19) United States
(12) Patent Application Publication
(10) Pub. No.: US 2006/0094794 A1
(43) Pub. Date: May 4, 2006

(54) Moisture resistant polyurethane prepolymers

(75) Inventors: Trent Shidaker, Royal Oak, MI (US); Brian Fogg, Rochester Hills, MI (US)

Correspondence Address: Patent Counsel;Huntsman Polyurethanes, 10003 Woodloch Forest Drive, The Woodlands, TX, 77380, US

(73) Assignee: Huntsman International LLC, Salt Lake City, UT (US)

(21) Appl. No.: 11/300,740

(22) Filed: Dec. 15, 2005

Related U.S. Application Data
(63) Continuation of application No. 10/643,874, filed on Aug. 20, 2003.
Application No. 10/643,874 is a continuation of application No. 09/270,473, filed on Mar. 15, 1999, now abandoned.
(60) Provisional application No. 60/078,124, filed on Mar. 16, 1998.
(60) Provisional application No. 60/078,712, filed on Mar. 20, 1998.

(51) Int. Cl. C08G 18/00; C08J 9/36

(52) U.S. Cl. 521/53; 528/44

(57) ABSTRACT

The disclosed invention relates to a method of making polyurethane prepolymers which have improved moisture resistance. The disclosed invention also relates to methods of manufacture of rebonded foam wherein the improved moisture resistant polyurethane prepolymers are used to bond polyurethane foam crumb.

This application claims the benefit of priority to U.S. Provisional application 60/078,124 filed Mar. 16, 1998 and to U.S. Provisional application 60/078,712 filed Mar. 20, 1998.

### FIELD OF THE INVENTION

The invention relates to polyurethane prepolymers and methods for reducing their sensitivity to humidity. The present invention also relates to rebonded polyurethane foam. The present invention particularly relates to flexible polyurethane rebond foam compositions.

### BACKGROUND OF THE INVENTION

Bonded foam products such as bonded polyurethane foams are typically used as carpet underlayment. Production of these bonded foam products typically entails (1) applying a coating of polyurethane prepolymer binder to particles of flexible polyurethane foam, (2) compressing the coated flexible foam particles in a mold to produce a compressed product, and (3) treating the compressed product with steam to cure the polyurethane prepolymer. Manufacture of these bonded foam products can be hindered by premature curing of the polyurethane prepolymer due to reaction with moisture prior to the compressing step. This premature curing can render the polyurethane prepolymer binder ineffective.

Previous attempts to impede premature curing have focused on temporarily capping the reactive isocyanate groups of the polyurethane prepolymer with blocking agents. These blocking agents, however, can increase undesirable emissions. In addition, capping the reactive isocyanate groups can produce a highly viscous polyurethane prepolymer that is difficult or impossible to process.

A need therefore exists for methods for reducing the reactivity of polyurethane prepolymer binders in bonded foams prior to curing. A need also exists for polyurethane prepolymers which are less sensitive to environmental conditions of high humidity such as those which exist in warm and humid climates.

### SUMMARY OF THE INVENTION

The invention relates to manufacture of a moisture resistant polyurethane prepolymer by treating an isocyanate material with a substance which provides hydrogen ions to the isocyanate material to produce an acidified isocyanate material, and reacting the acidified isocyanate material with an active hydrogen containing material to produce a moisture resistant polyurethane prepolymer. The substance which provides the hydrogen ions can be any substance that directly donates a hydrogen ion. The substance may also indirectly provide hydrogen ions when in the presence of water.

The invention also relates to a method of producing a polyurethane rebonded foam product having improved moisture resistance by employing the moisture resistant polyurethane prepolymer produced above as a binder for polyurethane foam crumb to produce treated foam crumb.

### DETAILED DESCRIPTION OF THE INVENTION

Glossary of Chemical Compounds:

Rubinate M is polymeric methane diphenyl diisocyante that has an isocyanate value of 31.5% and a functionality of 2.7 from ICI Americas

Rubinate 9041 is polymeric methane diphenyl diisocyante that has an isocyanate value of 31.9% and a functionality of 2.7 from ICI Americas

Voranol 3512 is a polyether triol that has a hydroxyl number of 48.1 from Dow Chemical Co.

Sundex 840 is an aromatic processing oil from Sun Oil Co.

In accordance with the invention, polyurethane prepolymers which have improved moisture resistance in moist environments are made by adding a chemical substance which directly or indirectly provides hydrogen ions to an isocyanate, preferably methane diphenyldiisocyante (“MDI”), to produce an acidified isocyanate. The acidified isocyanate is reacted with an active hydrogen containing material, preferably polyol, to produce a polyurethane prepolymer that has improved moisture resistance.

Useful chemical substances which directly donate a hydrogen ion, such as hydrogen chloride, hydrogen flouride, hydrogen bromide, phosphoric acid, nitrous acid, nitric acid, sulfurous acid, sulfuric acid, hypochlorous acid, chlorous acid, chloric acid, and perchloric acid. These substances may also indirectly provide hydrogen ions when in the presence of water, for example, benzoyl chloride and thionyl chloride. The active hydrogen containing material can be a polyether polyol having a functionality of about 2 to about 4, and an OH value of about 47 to about 55 mg KOH/g.

In an alternative embodiment, the chemical substances discussed above can be added to the active hydrogen materials such as polyols, and to inert additives such as processing oil which are employed in manufacture of the prepolymers.

In yet another embodiment, polyurethane prepolymers which have improved moisture resistance may be produced by adding a liquid acid material such as aqueous hydrochloric acid or an aqueous precursor thereof such as benzoyl chloride or thionyl chloride to a previously made polyurethane prepolymer.

In another embodiment, the present invention relates to a method for preparing flexible polyurethane rebond foam. In this method, flexible polyurethane foam crumb is coated with the polyurethane prepolymer of the invention. The coated foam crumb is compressed and treated with steam. The resulting rebonded foam product has a greatly reduced amount of unbonded foam crumb compared to the prior art.

The organic isocyanates and polyisocyanates which may be treated with acid for use in the present invention are those having a number average isocyanate functionality in the range of about 1.8 to about 4.0. Preferably, the number average isocyanate functionality is from about 2.3 to about 3.0.

Organic polyisocyanates which may be employed include, for example, any of the aliphatic, cycloaliphatic, araliphatic, or aromatic polyisocyanates known to those skilled in the art, especially those that are liquid at room temperature. Examples of suitable polyisocyanates include 1,6-hexamethylene diisocyanate, isophorone diisocyanate, 1,4-cyclohexane diisocyanate, 4,4′dicyclohexylmethane diisocyanate, 1,4-xylylene diisocyanate, 1,4-phenylene diisocyanate, 2,4-toluene diisocyanate, 2,6-toluene diisocyanate, 4,4′diphenylmethane diisocyanate (4,4′-MDI), 2,4′diphenylmethane diisocyanate (2,4′-MDI), polymethylene polyphenylene polyisocyanates (crude or polymeric MDI) and 1,5 naphthylene diisocyanate. Mixtures of these polyisocyanates can also be used. Moreover, polyisocyanate variants, i.e., polyisocyanates which have been modified by the introduction of urethane, allophanate, urea, biuret, carbodiimide, uretonimine, isocyanurate and/or oxazolidone residues can also be used in the present systems.

In general, aromatic polyisocyanates are preferred for use in the present invention, more preferably, aromatic polyisocyanates such as methane diphenyl diisocyante (“MDI”) such as 2,4′ MDI, 4,4′-MDI, and polymeric MDI (“PMDI”), MDI variants and mixtures thereof are preferred, most preferably 2,4′ MDI, 4,4′-MDI and PMDI. Most preferably, RUBINATE® series of polymeric isocyanates available from ICI Americas Inc are used in the invention.

Isocyanate-terminated prepolymers may also be employed in the invention for reaction with the active hydrogen containing material. Such isocyanate terminated prepolymers are generally prepared by reacting excess isocyanate with polyols, including aminated polyols, imine- or enamine-modified polyols, polyether polyols, polyester polyols or polyamines. Psuedoprepolymers, which are a mixture of prepolymer and one or more monomeric di- or polyisocyanates, may also be used.

Acidified isocyanates which may be used in the invention are prepared by adding acids such as hydrogen chloride acid and phosphoric acid, preferably anhydrous hydrogen chloride acid, to the isocyanate materials, preferably any of 2,4′MDI, 4,4′MDI, polymeric MDI, more preferably blends of 2,4′MDI, 4,4′MDI, and polymeric MDI. The acids are added in amounts sufficient to achieve a concentration of about 100 ppm to about 40,000 ppm of the acid, preferably hydrogen chloride acid, in the isocyanate reactive materials, preferably any of 2,4′MDI, 4,4′MDI, and polymeric MDI, preferably about 1400 ppm of hydrogen chloride acid.

Hydrogen chloride acid may be added as liquid HCl or as anhydrous HCl gas, preferably as anhydrous HCl gas, to the isocyanate to produce an acidified isocyanate for reaction with the hydrogen containing material to produce a polyurethane prepolymer having improved moisture resistance. These acid materials may be added in amounts sufficient to achieve a concentration of about 100 ppm to about 100,000 ppm, preferably about 100 ppm to about 4000 ppm of the acid material in the polyurethane prepolymer.

To illustrate acidification of MDI with anhydrous HCl gas, 1,075 grams of liquid MDI is transferred to a 2-liter round-bottom flask. Anhydrous hydrogen chloride gas is bubbled into the liquid MDI for 7.5 minutes using a Pyrex gas-dispersion tube. The resulting acidified MDI contains 1,820 ppm HCl.

Acidified polymeric isocyanates, preferably acidified PMDI, for use in the invention are prepared by adding an inorganic acid such as hydrogen chloride acid and phosphoric acid to PMDI in amounts sufficient to achieve a concentration of about 100 ppm to about 40,000 ppm of the acid in the PMDI, preferably about 1400 ppm. Preferably, anhydrous hydrogen chloride acid gas in an amount sufficient to achieve a concentration of about 100 ppm to about 4000 ppm in the PMDI, most preferably about 1400 ppm, is added to PMDI.

Active hydrogen containing materials which may be reacted with the acidified isocyanate to provide polyurethane prepolymers suitable for use in the invention include polyether polyols and polyester polyols, hydrocarbon polyols, amine functional polyols, and natural products such as castor oil, preferably polyether polyols, more preferably mid-range polyether polyols having a molecular weight of about 1000 to about 4000 and high molecular weight polyether polyols having a molecular weight of about 4,000 to about 10,000 most preferably polyether triols with hydroxyl values between about 47 and about 57, hereinafter referred to as slabstock polyols. These polyols also may be reacted with isocyanate terminated polyurethane prepolymers for use in the invention.

Examples of hydrocarbon polyols include but are not limited to hydroxy terminated polybutadiene, hydrogenation products of hydroxy terminated polybutadiene, hydroxy terminated isoprene, and hydroxy terminated polyolefins. Examples of amine functional polyols include but are not limited to amine terminated polyoxyalkylene glycols such as amine terminated polyoxypropylene.

Polyether polyols which may be used include but are not limited to those selected from the following classes of compositions, alone or in admixture:

alkylene oxide adducts of polyhydroxy-alkanes;

alkylene oxide adducts of non-reducing sugars and sugar derivatives;

alkylene oxide adducts of phosphorus and polyphosphorus acids; and

alkylene oxide adducts of polyphenols.

Examples of alkylene oxide adducts of polyhydroxyalkanes useful herein are adducts of ethylene glycol, propylene glycol, 1,3-dihydroxypropane, 1,4-dihydroxybutane, and 1,6-dihydroxyhexane, glycerol, 1,2,4-trihydroxybutane, 1,2,6-trihydroxyhexane, 1,1,1-trimethylolethane, 1,1,1-trimethylolpropane, pentaerythritol, polycaprolactone, xylitol, arabitol, sorbitol, mannitol, and the like. Preferred herein as alkylene oxide adducts of polyhydroxyalkanes are the ethylene oxide adducts of trihydroxyalkanes. Other useful adducts include ethylene diamine, glycerin, ammonia, 1,2,3,4-tetrahydroxy butane, fructose, and sucrose.

Polyether polyols especially useful for preparing the polyurethane prepolymers of the invention have a functionality of about 2 to about 4 and an OH value (in mg KOH/g) of between about 20 and about 80, preferably between about 40 and about 70, more preferably between about 45 and about 60 and most preferably between about 47 and about 55. The polyol has an equivalent molecular weight of between about 1000 and about 2000 meaning that a difunctional polyether polyol has a molecular weight of between about 2000 and about 4000, a trifunctional polyol has a molecular weight of between about 3000 and about 6000, etc.

These polyether polyols are obtained by the polymerization of a cyclic oxide, such as ethylene oxide and propylene oxide, in the presence of a polyfunctional initiator. Suitable initiators contain a plurality of active hydrogen atoms and include water and polyols, for example ethylene glycol, propylene glycol, diethylene glycol, dipropylene glycol, cyclohexane dimethanol, resorcinol, bisphenol A, glycerol, trimethylolpropane, 1,2,6-hexanetriol, pentaerythritol, sorbitol and sucrose. Mixtures of initiators and/or cyclic oxides may be used.

Polyester polyols having difunctionality are useful in the present invention. Examples of useful polyester polyols include, for example, polybutanediol adipate and poly epsilon—caprolactone.

Suitable polyester polyols which may be employed in the invention include, for example, those prepared by reacting a polycarboxylic acid or anhydride with a polyhydric alcohol. The polycarboxylic acids may be aliphatic, cycloaliphatic, aromatic and/or heterocyclic and may be substituted (e.g., with halogen atoms) and/or unsaturated. Examples of suitable carboxylic acids and anhydrides include succinic acid; adipic acid; suberic acid; azelaic acid; sebacic acid; phthalic acid; isophthalic acid; terephthalic acid; trimellitic acid; phthalic acid anhydride; tetrahydrophthalic acid anhydride; hexahydrophthalic acid anhydride; tetrachlorophthalic acid anhydride; endomethylene tetrahydrophtalic acid anhydride; glutaric acid anhydride; maleic acid; maleic acid anhydride; fumaric acid; dimeric and trimeric fatty acids, such as those of oleic acid, which may be in admixture with monomeric fatty acids. Simple esters of polycarboxylic acids may also be used, such as terephthalic acid dimethyl ester, terephthalic acid bisglycol ester and mixtures thereof. Examples of suitable polyhydric alcohols include ethylene glycol, 1,2-propylene glycol; 1,3-propylene glycol; 1,3-1,4-, 1,2- and 2,3-butylene glycol; 1,6-hexane diol; 1,8-octane diol; neopentyl glycol; cyclohexane dimethanol (1,4-bis-hydroxylmethyl cyclohexane); 2-methyl-1,3-propane diol, glycerol; trimethylol propane; 1,2,6-hexane triol; 1,2,4-butane triol; trimethylol ethylene; pentaerythritol; quitinol; mannitol; sorbitol; methylglycoside; diethylene glycol; triethylene glycol; tetraethylene glycol; polyethylene glycols; dipropylene glycol; polypropylene glycols; dibutylene glycol; polybutylene glycols and the like. The polyesters may contain some terminal carboxy groups although preferably they are hydroxyl-terminated. It is also possible to use polyesters of lactones such as caprolactone, or hydroxy carboxylic acids such as hydroxy caproic acid or hydroxyacetic acid.

Simple esters of polycarboxylic acids may also be used, such as terephthalic acid dimethyl ester, terephthalic acid bisglycol ester and mixtures thereof. Examples of suitable polyhydric alcohols include ethylene glycol, 1,2-propylene glycol; 1,3-propylene glycol; 1,3-, 1,4-, 1,2- and 2,3-butylene glycol; 1,6-hexane diol; 1,8-octane diol; neopentyl glycol; cyclohexane dimethanol (1,4-bis-hydroxylmethyl cyclohexane); 2-methyl-1,3-propane diol, glycerol; trimethylol propane; 1,2,6-hexane triol; 1,2,4-butane triol; trimethylol ethylene; pentaerythritol; quitinol; mannitol; sorbitol; methylglycoside; diethylene glycol; triethylene glycol; tetraethylene glycol; polyethylene glycols; dipropylene glycol; polypropylene glycols; dibutylene glycol; polybutylene glycols and the like. The polyesters may contain some terminal carboxy groups although preferably they are hydroxyl-terminated. It is also possible to use polyesters of lactones such as caprolactone, or hydroxy carboxylic acids such as hydroxy caproic acid or hydroxyacetic acid.

Other active hydrogen containing materials useful in the present invention include but are not limited to poly(oxypropylene) glycols, triols, tetrols and hexols and any of these that are capped with ethylene oxide. These polyols also include poly(oxypropyleneoxy-ethylene)polyols. The oxyethylene content is preferably less than about 80 weight percent of the total and more preferably less than about 40 weight percent. The ethylene oxide, when used, can be incorporated in any way along the polymer chain, for example, as internal blocks, terminal blocks, or randomly distributed blocks, or any combination thereof.

Polyamines, amine-terminated polyols, and polymercaptans also may be employed a active hydrogen containing materials for use in the invention.

Copolymer polyols, i.e., polyether polyols containing stably dispersed polymers such as acrylonitrile-styrene copolymers also may be used as hydrogen containing materials. Production of these copolymer polyols can be from reaction mixtures comprising a variety of other materials, including, for example, catalysts such as azobisisobutyronitrile; copolymer polyol stabilizers; and chain transfer agents such as isopropanol.

Any method known to those skilled in the art of preparing polyurethane prepolymers can be used to prepare the moisture resistant polyurethane prepolymers of the present invention. Generally, these polyurethane prepolymers can be prepared by admixing the acidified isocyanate and the active hydrogen containing materials to provide an admixture and stirring it for a convenient period, for example, overnight. Alternatively, the admixture can be heated to about 55° C. and stirred for about 1 hour. Preferably, the admixture is stirred without temperature control for about 10 to about 24 hours under an inert gas pad. Stirring continues until most of the active hydrogens have reacted with the isocyanate groups.

In the present invention, the acidified isocyanate is admixed with an isocyanate reactive compound to prepare a polyurethane prepolymer which can be used as a binder for polyurethane foam crumb.

The moisture resistant polyurethane prepolymers of the invention are prepared from a formulation including acidified isocyanate reactive materials such as 2,4′ MDI, 4,4′ MDI and PMDI, and an active hydrogen containing material, preferably a polyol. The exact ratio of acidified isocyanate or polyisocyanate, and active hydrogen containing material used to prepare the moisture resistant polyurethane prepolymers of the invention may vary depending upon the desired properties of the prepolymer. For example, if a specific prepolymer viscosity is desired, then the ratio of isocyanate and active hydrogen containing components can vary depending upon the materials chosen for the prepolymer admixture. However, the prepolymer formulation may include as much acidified MDI or acidified PMDI as can be easily handled during production of the prepolymer.

Preferably, the moisture resistant polyurethane prepolymers of the invention are produced by reacting acidified MDI and polyol. Generally, acidified MDI may be used in an amount of about 5 to about 95 parts by weight, and polyol may be used in an amount of about 5 to about 95 parts by weight, all amounts based on total weight of the MDI-polyol admixture. Preferably, slabstock polyol in an amount of about 35 parts by weight and MDI in an amount of about 40 parts by weight are used. To illustrate acidification of a polyurethane prepolymer, a polyurethane prepolymer is first made from 40 parts MDI, 35 parts slabstock polyol and 25 parts aromatic oil. Then, 0.00033 parts 12M aqueous HCl is added to the polyurethane prepolymer by mixing.

Alternatively, an existing polyurethane prepolymer is reacted with acidified isocyanate to produce a polyurethane prepolymer in accordance with the invention. Generally, acidified polyurethane prepolymer may be used in an amount of about 5 to about 95 parts by weight, and polyol may be used in an amount of about 5 to about 95 parts by weight, all amounts based on total weight of the acidified polyurethane prepolymer admixture.

The moisture resistant polyurethane prepolymers of the present invention can be employed as a binder in any way known to those skilled in the art of preparing rebond foam from polyurethane foam crumb. For example, if the moisture resistant prepolymer is sprayed upon bulk foam crumb, the foam crumb can be tumbled to insure a uniform coating of all surface areas of the foam crumb. In the alternative, the foam crumb can be suspended in a column of air and the polyurethane prepolymer applied in a stream or as an aerosol. Regardless, the moisture resistant prepolymer is applied in an amount of from about 5 percent, preferably from about 7 percent, more preferably from about 8 percent of the total weight of the foam crumb and moisture resistant prepolymer.

The foam crumb can be of any size which is compatible with equipment available to coat the foam crumb. Preferably, the foam crumb pieces have dimensions of from about 0.1 to about 5 cm, more preferably of from about 0.25 to about 7.5 cm, and even more preferably of from about 0.63 to about 1.27 cm.

In addition to bonding polyurethane foam crumb, the moisture resistant prepolymers of the invention may be used to bind other materials or mixtures of polyurethane foam and other materials. For example, the moisture resistant polyurethane prepolymers of invention may be used to bind wood, paper, and inorganic materials such as sand and the like. For example, a product including paper and foam crumb may be prepared by the method of the invention. Other uses for the moisture resistant polyurethane prepolymers of the invention include adhesives such as for bonding of rubber crumb, metal coatings, especially moisture curable coatings, encapsulants, sealants, wood binders, concrete additives, and asphalt additives. Flexible foam crumb containing urea groups, thiourethane groups, and the like, in addition to or in place of polyurethane groups, also can be used to prepare rebond foam pads by the method of the present invention.

To evaluate the moisture resistance of polyurethane prepolymers of the invention, flexible polyurethane foam crumb coated with the polyurethane prepolymers of the invention is placed for two minutes in a mold saturated with steam. The treated foam crumb is compressed in the mold to produce a bonded preform. After compression, the preform is subjected to steam to cure any remaining polyurethane prepolymer. The resulting cured product is removed from the mold.

The foam crumb that is poorly bonded due to premature curing of the prepolymer due to reaction with humidity from the steam in the mold prior to compression is separated from the cured product by manual tearing. The amount of prematurely cured polyurethane prepolymer as a percentage of the total weight of the foam block plus polyurethane prepolymer is used to measure the amount of polyurethane prepolymer that cured prematurely prior to the compression step. As shown in the non-limiting examples below, the polyurethane prepolymers produced in accordance with the invention show greatly reduced premature curing.

The rebond foam product of the present invention can be used for applications such as carpet underlayment, packing foam, filler for structural voids, absorbent medium and the like. The rebond foams of the present invention, due to their superior properties are particularly useful in carpet pad applications, packaging foams, automotive headliners, sound insulation applications such as automotive sound insulation, and shock absorption applications such as shoe soles.

The following non-limiting examples further illustrate the present invention. Amounts are in weight parts or weight percentages unless otherwise indicated.

### EXAMPLE 1

### Control

40 parts Rubinate 9041 is mixed with 35 parts Voranol 3512 and 25 parts Sundex 840 to produce a reaction mixture. The reaction mixture is heated overnight at 45° C. to produce a polyurethane prepolymer. 14.1 grams of the prepolymer is mixed with 141.1 grams of polyurethane foam crumb. The resulting mixture is placed into a mold for two minutes in a mold saturated with steam at 100° C. under ambient pressure. The steam treated mixture then is compressed in the mold to produce a preform. The compressed preform then is subjected to steam at 100° C. and atmospheric pressure for 3.5 minutes to cure any remaining polyurethane prepolymer. The resulting preform then is removed from the mold. Foam crumb that is poorly bonded is removed from the preform by manual tearing. The amount of foam crumb removed by tearing, as a percentage of the total weight of the foam block plus polyurethane prepolymer, is used to gauge the amount of prematurely cured polyurethane prepolymer. The result is shown in Table 1.

### EXAMPLE 2

The procedure of example 1 is followed except that 600 ppm benzoyl chloride, based on total prepolymer weight, is added to the reaction mixture. The amount of foam crumb removed, as a percentage of the total weight of the foam block plus polyurethane prepolymer, is shown in Table I.

### EXAMPLE 3

The procedure of example 1 is followed except that 6000 ppm, based on total prepolymer weight, benzoyl chloride is added to the reaction mixture. The amount of foam crumb removed, as a percentage of the total weight of the foam block plus polyurethane prepolymer, is shown in Table I.

### EXAMPLE 4

The procedure of example 1 is followed except that 330 ppm, based on total prepolymer weight, of 12 M aqueous hydrochloric acid is added to the reaction mixture. The amount of foam crumb removed, as a percentage of the total weight of the foam block plus polyurethane prepolymer, is shown in Table I.

### EXAMPLE 5

The procedure of example 1 is followed except that 180 ppm, based on total prepolymer weight, anhydrous hydrogen chloride is added to the reaction mixture. The amount of foam crumb removed, as a percentage of the total weight of the foam block plus polyurethane prepolymer, is shown in Table I.

### EXAMPLE 6

The procedure of example 1 is followed except that 370 ppm, based on total prepolymer weight, anhydrous hydrogen chloride is added to the reaction mixture. The amount of foam crumb removed, as a percentage of the total weight of the foam block plus polyurethane prepolymer, is shown in Table I.

### EXAMPLE 7

The procedure of example 1 is followed except that 730 ppm, based on total prepolymer weight, anhydrous hydrogen chloride is added to the reaction mixture. The amount of foam crumb removed, as a percentage of the total weight of the foam block plus polyurethane prepolymer, is shown in Table I.

### EXAMPLE 8

The procedure of example 1 is followed except that 3200 ppm, based on total prepolymer weight, thionyl chloride is added to the reaction mixture. The amount of foam crumb removed, as a percentage of the total weight of the foam block plus polyurethane prepolymer, is shown in Table I.

### EXAMPLE 9

The procedure of example 1 is followed except that 98000 ppm, based on total prepolymer weight, thionyl chloride is added to the reaction mixture. The amount of foam crumb removed, as a percentage of the total weight of the foam block plus polyurethane prepolymer, is shown in Table I.

TABLE I

| | | Amount of form crumb removed |
|---|---|---|
| | | by tearing as percentage of |
| | | total weight of foam block |
| Example | Prepolymer | plus prepolymer (%) |
| 1 | Control | 20.1 |
| 2 | Control w/600 ppm | 17.5 |
| | benzoyl chloride | |
| 3 | Control w/6000 ppm | 14.1 |
| | benzoyl chloride | |
| 4 | Control w/330 ppm | 11.5 |
| | hydrochloric acid | |
| 5 | Control w/180 ppm | 16.8 |
| | Anhydrous hydrogen | |
| | chloride | |
| 6 | Control w/370 ppm | 15.1 |
| | Anhydrous hydrogen | |
| | chloride | |
| 7 | Control w/730 ppm | 11.8 |
| | Anhydrous hydrogen | |
| | chloride | |
| 8 | Control w/3200 ppm | 17.4 |
| | Thionyl chloride | |
| 9 | Control w/98000 ppm | 8.00 |
| | Thionyl chloride | |

Examples 10-25 below illustrate manufacture of polyurethane prepolymers made with differing levels of HCL addition in various blends of isocyanate. The polyurethane prepolymers are made as in Example 1 except that the acidified blends of isocyanate made with anhydrous hydrogen chloride shown in Table 2 are employed. In Table 2, the % concentrations of isocyanate A, isocyanate B and isocyanate C are weight percent of isocyanate A, isocyanate B and isocyanate C based on total weight of the blends of isocyanate A, isocyanate B and isocyanate C. The results are shown in Table 2.

TABLE 2

| | | | | | Calculated | Amount of form crumb removed |
|---|---|---|---|---|---|---|
| | | | | Mass Fraction | HCL conc, in | by tearing as percentage of |
| | Isocyanate | Isocyanate | Isocyanate | diisocyante added | MDI blend⁴ | total weight of foam block |
| Example | A¹ conc. % | B² conc. % | C³ conc. % | to MDI blend⁴ | (ppm) | plus prepolymer (%) |
| 10 | 0.0 | 75.0 | 25.0 | 0.25 | 0.0 | 37.5 |
| 11 | 33.4 | 50.0 | 16.7 | 0.25 | 667 | 33.4 |
| 12 | 66.7 | 25.0 | 8.34 | 0.25 | 1333 | 27.9 |
| 13 | 100.0 | 0.0 | 0.0 | 0.25 | 2000 | 22.0 |
| 14 | 0.0 | 63.3 | 36.7 | 0.37 | 0.0 | 34.2 |
| 15 | 28.2 | 42.2 | 29.7 | 0.37 | 563 | 28.8 |
| 16 | 56.3 | 21.1 | 22.6 | 0.37 | 1125 | 28.2 |
| 17 | 84.4 | 0.0 | 15.6 | 0.37 | 1688 | 23.2 |
| 18 | 0.0 | 51.7 | 48.3 | 0.48 | 0.0 | 37.8 |
| 19 | 23.0 | 34.5 | 42.6 | 0.48 | 459 | 40.1 |
| 20 | 46.0 | 17.2 | 36.8 | 0.48 | 919 | 34.9 |
| 21 | 68.9 | 0.0 | 31.1 | 0.48 | 1378 | 29.1 |
| 22 | 0.0 | 40.0 | 60.0 | 0.60 | 0.0 | 42.1 |
| 23 | 17.8 | 26.7 | 55.6 | 0.60 | 355 | 36.5 |
| 24 | 35.6 | 13.3 | 51.1 | 0.60 | 711 | 29.2 |
| 25 | 53.3 | 0.0 | 46.7 | 0.60 | 1066 | 21.3 |

¹Isocyanate A is a blend of 75% Rubinate M and 25% 4,4′MDI that is acidified to 2000 ppm HCL.
²Rubinate M
³4,4′ MDI
⁴MDI blend is blend of indicated amounts of Isocyanate A, Isocyanate B and Isocyanate C.

1-36. (canceled)

37. A process comprising bonding foam crumb with a polyurethane prepolymer prepared from an isocyanate material comprising methanediphenyl diisocyanate wherein the isocyanate material has been treated with an acid to achieve a concentration of about 100 ppm to about 4000 ppm of the acid in the polyurethane prepolymer.

38. The process of claim 37, wherein the isocyanate material has a number average isocyanate functionality of about 2.3 to about 3.0.

39. The process of claim 37, wherein the polyurethane prepolymer is prepared by reacting a mixture comprising the isocyanate material and a polyol.

40. The process of claim 39, wherein the mixture further comprises a processing oil.

41. The process of claim 37, wherein the methanediphenyl diisocyanate is selected from 2,4-methanediphenyl diisocyanate, 4,4′-methanediphenyl diisocyanate and polymeric methanediphenyl diisocyanate.

42. The process of claim 37, wherein the isocyanate material consists essentially of 2,4-methanediphenyl diisocyanate, 4,4′-methanediphenyl diisocyanate, and/or polymeric methanediphenyl diisocyanate.

43. The process of claim 37, wherein the acid is selected from the group consisting of hydrogen chloride, hydrogen fluoride, hydrogen bromide, phosphoric acid, nitrous acid, nitric acid, sulfurous acid, sulfuric acid, hypochlorous acid, chlorous acid, chloric acid, perchloric acid, benzoyl chloride, and thionyl chloride.

44. The process of claim 37, wherein the acid includes anhydrous hydrogen chloride.

45. The process of claim 39, wherein the polyol includes a polyether polyol.

46. The process of claim 45, wherein the polyether polyol is a polyoxypropylene-polyoxyethylene polyol.

47. The process of claim 37, wherein the foam crumb includes flexible polyurethane foam crumb.

48. The process of claim 37, wherein the foam crumb has dimensions in the range of about 0.1 cm to about 5 cm.

49. The process of claim 37, wherein the amount of the polyurethane prepolymer used to bond the foam crumb is, relative to the total weight of foam crumb and polyurethane prepolymer, at least about 5 wt %.

50. The process of claim 37, wherein the process comprises spraying the polyurethane prepolymer on the foam crumb to provide sprayed foam crumb.

51. The process of claim 50, wherein the process further comprises tumbling the sprayed foam crumb.

52. The process of claim 51, wherein the process further comprises curing the polyurethane prepolymer.

53. The process of claim 52, wherein the curing includes subjecting the polyurethane prepolymer to steam.

54. An article produced in accordance with the process of claim 37.

55. The article of claim 54, wherein the article is a carpet pad, a packaging foam, an automotive headliner, a sound installation, or a shoe sole.

56. The article of claim 55, wherein the article is a carpet pad.

57. A process for producing a rebonded foam product comprising the steps of:
A) providing foam crumb;
B) providing a polyurethane prepolymer adhesive having a concentration of about 100 ppm to about 4000 ppm of acid in the prepolymer, said adhesive prepared by combining at least the following ingredients:
i) one or more polyisocyanates of the MDI series;
ii) at least one added acid; and
iii) at least one polyol;
C) applying the polyurethane prepolymer adhesive to the foam crumb under conditions which promote the distribution of the prepolymer throughout the bulk of the foam crumb, thereby forming a prepolymer treated mass of foam crumb;
D) consolidating and compressing the prepolymer treated mass of foam crumb under conditions which provide for curing of the polyurethane prepolymer to form rebonded foam particle; and
E) recovering the rebonded foam article.
